(19) United States
(12) Patent Application Publication
(10) Pub. No.: US 2013/0088803 A1
(43) Pub. Date: Apr. 11, 2013

(54) POWER SUPPLY APPARATUS

(71) Applicants: Jung Hyun Kim, Gyeonggi-do (KR); Jung Chul Gong, Seoul (KR)

(72) Inventors: Jung Hyun Kim, Gyeonggi-do (KR); Jung Chul Gong, Seoul (KR)

(21) Appl. No.: 13/372,417

(22) Filed: Feb. 13, 2012

(30) Foreign Application Priority Data
Oct. 6, 2011 (KR) 10-2011-0101911

(51) Int. Cl. H02H 9/02

(52) U.S. Cl. 361/93.7; 361/93.1

(57) ABSTRACT

The present invention relates to a power supply apparatus including: a converting unit for converting an applied voltage into a predetermined level; a switching unit opened or closed to control current flowing in the converting unit; a detecting unit for detecting occurrence of overcurrent when a voltage applied to the switching unit is higher than a preset reference voltage; and a control unit for performing a protection operation when the overcurrent is detected more than a predetermined number of times within a predetermined time from when the overcurrent is detected and can prevent malfunction due to noises.

### CROSS-REFERENCE TO RELATED APP CATIONS

Claim and incorporate by refenencB domestic priority application and foreign priority application as follows:

### “CROSS REFERENCE TO RELATED APPLICATION

This application claims the benefit under 35 U.S.C. Section 119 of Korean Patent Application Serial No. 10-2011-0101911, entitled filed Oct. 6, 2011, which is hereby incorporated by reference in its entirety into this application.”

### BACKGROUND OF THE INVENTION

1. Field of the Invention

The present invention relates to a power supply apparatus, and more particularly, to a power supply apparatus having a protection circuit for protecting a power supply apparatus from excessive current.

2. Description of the Related Art

In today's information society, importance of display devices is more emphasized as a visual information transmission medium, but their requirements such as low power consumption, quantification, and high definition should be satisfied in order to occupy an important position in the future.

This display device has a driving unit for applying pulses to a plurality of electrodes, and a power supply apparatus of the display device supplies power to operate the driving unit. At this time, generally, a switching mode power supply (SMPS) is used as the power supply apparatus of the display device.

Here, the SMPS is an apparatus which outputs a DC voltage of a desired level using a converter after converting the DC voltage into a sine wave voltage using a switch device such as a metal-oxide-semiconductor field effect transistor (MOSFET).

Meanwhile, the display device is often damaged due to excessive current instantaneously applied by various external factors. In order to protect the display device from this excessive current, the power supply apparatus includes a protection circuit to determine whether the excessive current is applied or not and performs a protection operation of stopping driving of the power supply apparatus when the excessive current is applied.

A power supply apparatus in accordance with the prior art includes a sensing resistor for detecting current flowing in an inductor or a transformer, a protection circuit for performing a protection operation when the voltage detected by the sensing resistor is higher than a reference voltage Vref, and a driving circuit for interrupting power applied to a gate of a switch device by the protection operation of the protection circuit.

FIG. 1 is a view for explaining a protection operation of the power supply apparatus in accordance with the prior art and sequentially shows the voltage sensed by the sensing resistor, whether the protection circuit performs a protection operation or not, and a gate voltage of the switch device output from the driving circuit.

Referring to FIG. 1, the power supply apparatus in accordance with the prior art has a problem that a protection operation is performed even though a single noise is applied.

Accordingly, there is a problem of malfunction of the protection circuit due to noises.

Therefore, in this technology field, there is a demand for ways to prevent the malfunction of the protection circuit due to noises by distinguishing excessive current and noises.

### SUMMARY OF THE INVENTION

The present invention has been invented in order to overcome the above-described problems and it is, therefore, an object of the present invention to provide a power supply apparatus capable of preventing malfunction due to noises by performing a protection operation when excessive current is detected more than a predetermined number of times within a predetermined time.

In accordance with one aspect of the present invention to achieve the object, there is provided a power supply apparatus including: a converting unit for converting an applied voltage into a predetermined level; a switching unit opened or closed to control current flowing in the converting unit; a detecting unit for detecting occurrence of overcurrent when a voltage applied to the switching unit is higher than a preset reference voltage; and a control unit for performing a protection operation when the overcurrent is detected more than a predetermined number of times with'n a predetermined time from when the overcurrent is detected.

Here, the control unit performs a protection operation to open the switching unit when the overcurrent is detected more than the predetermined number of times within the predetermined time from when the overcurrent is detected.

Further, the control unit closes the switching unit when the overcurrent is detected less than the predetermined number of times within the predetermined time from when the overcurrent is detected.

And, the control unit includes a counter for counting the number of times the overcurrent is detected.

At this time, the counter counts the number of times the overcurrent is detected within the predetermined time from when the overcurrent is detected.

Further, the control unit further includes a delay unit which detects the time elapsed from when the overcurrent is detected and resets information on the number of times of the overcurrent counted by the counter when the overcurrent is detected less than the predetermined number of times within the predetermined time.

Moreover, the control unit further includes a protector which performs a protection operation to open the switching unit when the overcurrent is detected more than the predetermined number of times within the predetermined time from when the overcurrent is detected.

In addition, the control unit further includes a control signal generator which outputs a control signal for opening or closing the switching unit.

Here, the control signal generator outputs the control signal for opening the switching unit when the protector performs a protection operation.

And, the detecting unit includes a comparator which compares the voltage applied to the switching unit with the reference voltage and outputs an overcurrent signal when the voltage applied to the switching unit is higher than the reference voltage, and the control unit performs a protection operation when the overcurrent signal is output more than the predetermined number of times within the predetermined time from when the overcurrent signal is output.

Further, the detecting unit further includes a sensing resistor for detecting the voltage applied to the switching unit.

At this time, the voltage applied to the switching unit is a voltage output from a source terminal of the switching unit.

Meanwhile, the converting unit is an inductor which boosts the applied voltage to a predetermined level and includes a rectifying unit connected to the inductor in series to prevent a back flow of current and an output unit for discharging and outputting the voltage applied from the switching unit.

Here, the control unit outputs the control signal for opening or closing the switching unit, and the switching unit is opened or closed according to the control signal output from the control unit to apply or interrupt the boosted voltage to the output unit.

Further, meanwhile, the converting unit is a transformer with a primary winding and a secondary winding to which power is induced from the primary winding, and the power supply apparatus is an SMPS type.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view for explaining a protection operation of a power supply apparatus in accordance with the prior art;

FIG. 2 is a schematic configuration diagram of a power supply apparatus in accordance with an embodiment of the present invention;

FIG. 3 is a detailed configuration diagram of the power supply apparatus shown in FIG. 2;

FIG. 4 is a view for explaining a protection operation of the power supply apparatus in accordance with an embodiment of the present invention, wherein FIG. 4a is a view for explaining an operation of the power supply apparatus when overcurrent is detected less than a predetermined number of times within a predetermined time, and FIG. 4b is a view for explaining an operation of the power supply apparatus when the overcurrent is detected more than the predetermined number of times within the predetermined time; and

FIG. 5 is a detailed configuration diagram of the power supply apparatus when the power supply apparatus shown in FIG. 2 is a boost converter.

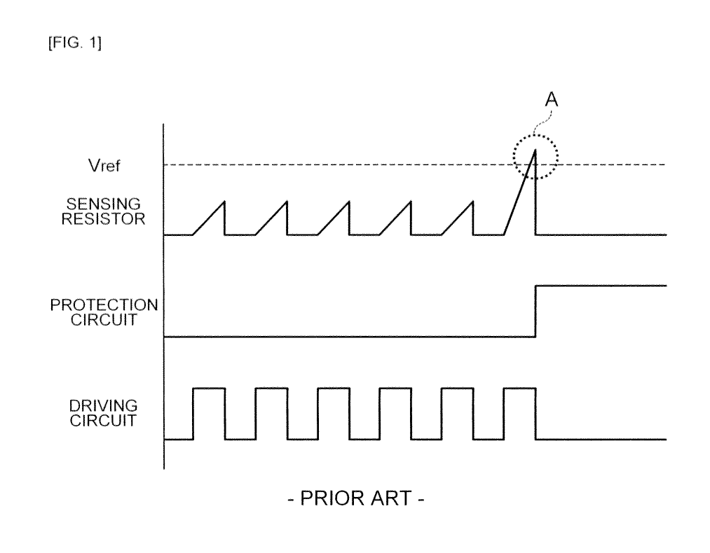

### DETAILED DESCRIPTION OF THE PREFERABLE EMBODIMENTS

The terms or words used in the present specification and claims should not be interpreted as being limited to typical or dictionary meanings, but should be interpreted as having meanings and concepts relevant to the technical spirit of the present invention based on the rule according to which an inventor can appropriately define the concept of the term to describe his/her own invention in the best manner.

Therefore, configurations shown in embodiments and the drawings of the present invention rather are examples of the most exemplary embodiment and do not represent all of the technical spirit of the invention. Thus, it will be understood that various equivalents and modifications that replace the configurations are possible when filing the present application.

Hereinafter, an embodiment of the present invention will be described in detail with reference to the accompanying drawings.

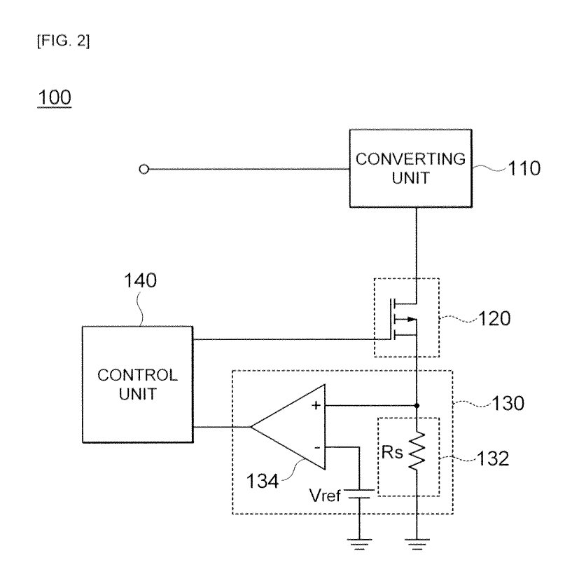

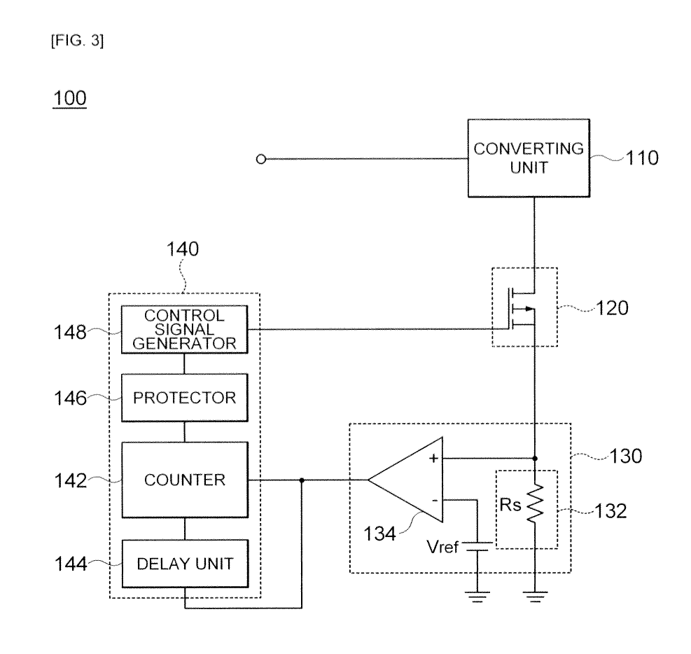

FIG. 2 is a schematic configuration diagram of a power supply apparatus in accordance with an embodiment of the present invention, and FIG. 3 is a detailed configuration diagram of the power supply apparatus shown in FIG. 2.

As shown in FIGS. 2 and 3, a power supply apparatus 100 includes a converting unit 110, a switching unit 120, a detecting unit 130, and a control unit 140.

Here, the power supply apparatus 100 uses a switching mode power supply (SMPS) type. The SMPS is an apparatus which outputs a DC voltage of a desired level using a converter after converting the DC voltage into a sine wave voltage using a switch device such as a metal-oxide-semiconductor field effect transistor (MOSFET).

The converting unit 110 as a means of converting an applied voltage into a predetermined level may consist of an inductor L for boosting the applied voltage to the predetermined level or a transformer with a primary winding L1 and a secondary winding L2 to which power is induced from the primary winding L1.

If the converting unit 110 is the inductor L, the power supply apparatus 100 may consist of a boost converter (also referred to as a step-up converter) and so on, and if the converting unit 110 is the transformer, the power supply apparatus 100 may consist of a flyback converter and so on. An operation of the boost converter or the flyback converter will be described in detail below.

The switching unit 120 is a switch device opened (turned off) or closed (turned on) to control current flowing in the converting unit 110. This switching unit 120 consists of a switch device which can flow high current and may consist of a bipolar junction transistor (BJT), an insulated gate bipolar transistor (IGBT), a MOSFET, and so on.

The detecting unit 130 is a means of detecting occurrence of overcurrent when a voltage applied to the switching unit 120 is higher than a preset reference voltage Vref and may include a sensing resistor 132 and Rs and a comparator 134.

Here, the sensing resistor 132 and Rs detects a voltage output from a source terminal of the switching unit 120, that is, the voltage applied to the switching unit 120, and the comparator 134 compares the voltage detected by the sensing resistor 132 and Rs with the reference voltage Vref and outputs an overcurrent signal of detecting the occurrence of the overcurrent when the voltage detected by the sensing resistor 132 and Rs is higher than the reference voltage Vref.

The control unit 140 is a micom which generally controls the power supply apparatus 100 and performs a protection operation when overcurrent is detected more than a predetermined number of times within a predetermined time t0 from when the overcurrent is detected.

More specifically, the control unit 140 performs a protection operation to open the switching unit 120 when the overcurrent is detected more than the predetermined number of times within the predetermined time t0 from when the overcurrent is detected and on the contrary, closes the switching unit 120 to normally operate the power supply apparatus 100 when the overcurrent is detected less than the predetermined number of times within the predetermined time to from when the overcurrent is detected.

This control unit 140 includes a counter 142, a delay unit 144, a protector 146, and a control signal generator 148. The counter 142 counts the number of times the overcurrent is detected. In other words, the counter 142 counts the number of times the overcurrent is detected within the predetermined time t0 from when the overcurrent is detected.

In more detail, the comparator 134 outputs the overcurrent signal when the voltage applied to the switching unit 120 is higher than the reference voltage Vref, and the counter 142 counts the number of times the overcurrent signal is output from when the overcurrent signal is output from the comparator 134 but counts the number of times the overcurrent signal is output within the predetermined time t0.

The delay unit 144 detects the time elapsed from when the overcurrent is detected and resets information on the number of times of the overcurrent counted by the counter 142 when the overcurrent is detected less than the predetermined number of times within the predetermined time.

In more detail, the delay unit 144 detects the time elapsed from when the overcurrent is detected and outputs a reset signal for resetting information on the number of times of the overcurrent signal counted by the counter 142 to the counter 142 so that the counter 142 can count the overcurrent signal again from the beginning in case that the number of times of the overcurrent signal counted by the counter 142 is less than the predetermined number of times when the elapsed time reaches the predetermined time t0.

In other words, when the overcurrent signal is not received again within the predetermined time t0 from when the overcurrent signal is output, the delay unit 144 outputs the reset signal to reset the information on the number of times of the overcurrent signal counted by the counter 142 so that the counter 142 counts the number of times of the overcurrent signal again from the beginning.

The protector 146 outputs a protection signal to perform a protection operation when the overcurrent is detected more than the predetermined number of times within the predetermined time t0 from when the overcurrent is detected.

The control signal generator 148 outputs a control signal for opening or closing the switching unit 120, more specifically, a pulse width modulation (PWM) type control signal. And, the control signal generator 148 outputs the control signal for opening the switching unit 120 when the protection signal is output from the protector 146.

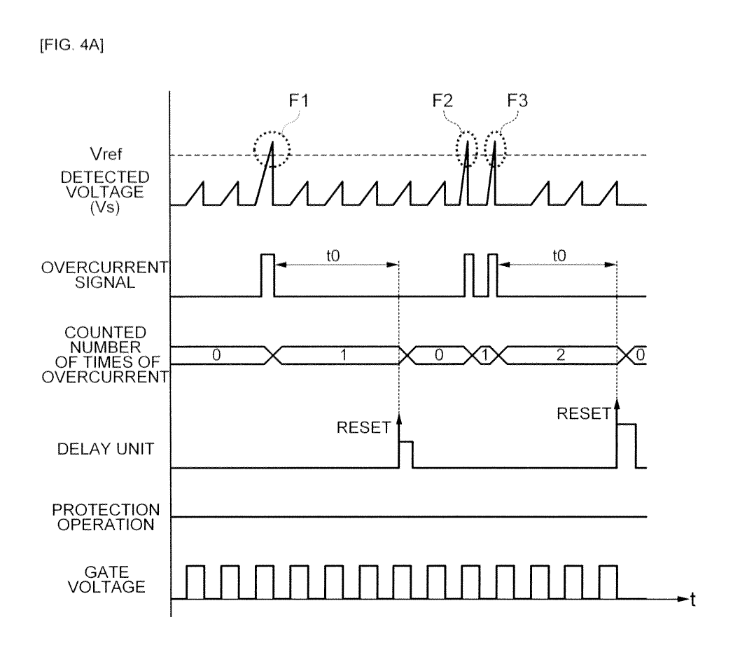

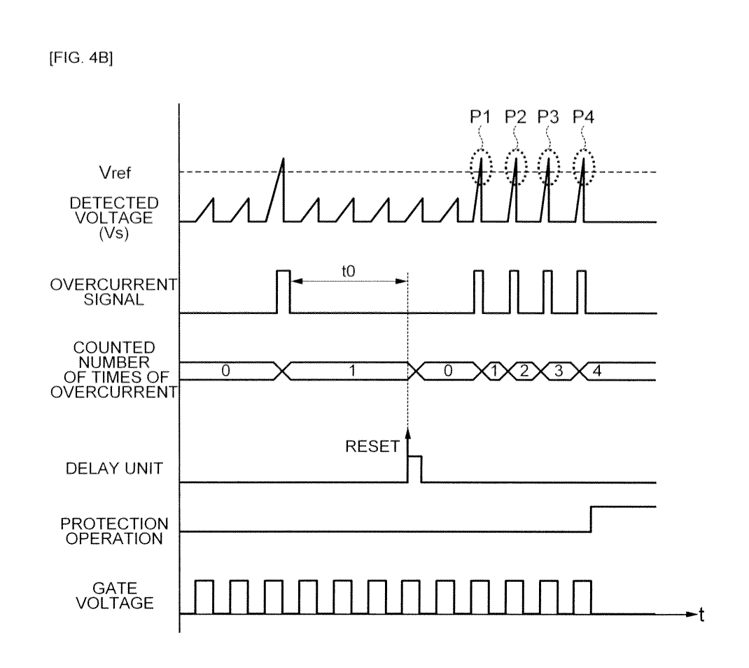

FIG. 4 is a view for explaining a protection operation of the power supply apparatus in accordance with an embodiment of the present invention, wherein FIG. 4a is a view for explaining an operation of the power supply apparatus when overcurrent is detected less than a predetermined number of times within a predetermined time, and FIG. 4b is a view for explaining an operation of the power supply apparatus when the overcurrent is detected more than the predetermined number of times within the predetermined time.

FIGS. 4a and 4b sequentially show the voltage (Vs) detected by the sensing resistor 132, the overcurrent signal output from the comparator 134, the number of times of the overcurrent counted by the counter 142, the reset signal output from the delay unit 144, whether the protector 146 performs a protection operation or not, and the gate voltage applied to the switching unit 120.

Referring to FIG. 4a, like an Fl waveform, when the overcurrent signal is output and the overcurrent signal is not output even after the predetermined time, the delay unit 144 outputs the reset signal, and the counter 142 resets the information on the counted number of times of the overcurrent signal. Then, since the protector 146 does not perform a protection operation, the power supply apparatus 100 normally performs an operation.

Further, like F2 and F3 waveforms of FIG. 4a, when the overcurrent signal is output and the overcurrent signal is not output more than the predetermined number of time within the predetermined time t0, the delay unit 144 outputs the reset signal, and the counter 142 resets the information on the counted number of times of the overcurrent signal. Then, since the protector 146 does not perform a protection operation, the power supply apparatus 100 normally performs an operation.

Referring to FIG. 4b, like P1, P2, P3, and P4 waveforms, after the overcurrent signal is output, when the overcurrent signal is output more than the predetermined number of times within the predetermined time t0, the protector 146 performs an operation for protecting the power supply apparatus 100 by performing a protection operation to output the control signal for opening the switching unit 120, that is, interrupting the gate voltage applied to the switching unit 120.

Hereinafter, when the power supply apparatus in accordance with an embodiment of the present invention consists of a boost converter, an operation process of the power supply apparatus will be described.

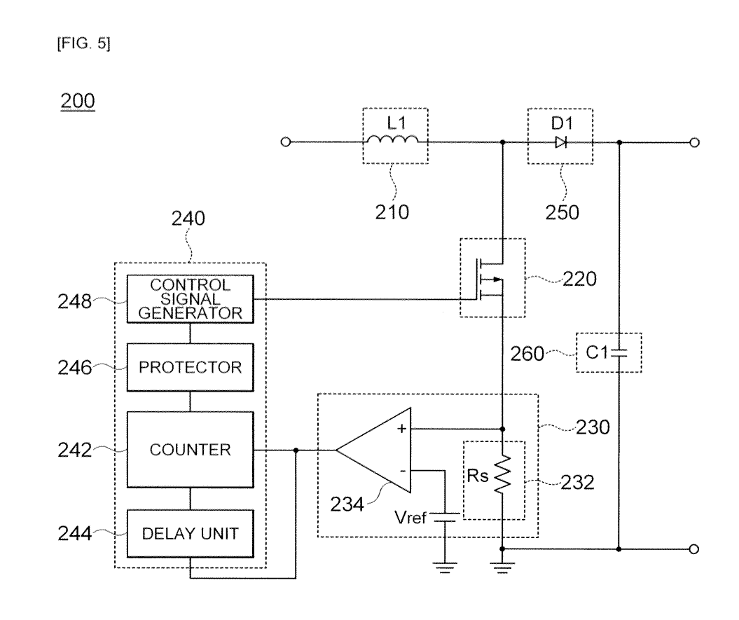

FIG. 5 shows a detailed configuration diagram of the power supply apparatus when the power supply apparatus shown in FIG. 2 is a boost converter.

As shown in FIG. 5, the power supply apparatus 200 includes a boost unit 210, a switching unit 220, a detecting unit 230, a control unit 240, a rectifying unit 250, and an output unit 260.

Here, the boost converter is a representative circuit of DC-DC converters and generates a stable output voltage by boosting an input voltage. This boost converter is also referred to as a step-up converter and can be used only when a ground GND of an input terminal Vin is the same as that of an output terminal Vout.

And, the boost converter is also referred to as a current-fed type converter when viewed from a load side since current is periodically and repeatedly supplied and interrupted to the load, and it is possible to check that an output voltage is always higher than an input voltage from the relation: input current×input voltage=output current×output voltage since current of the output terminal is always lower than current of the input terminal and there is no loss component according to an operation principle of the circuit.

The boost unit 210 is a means of boosting an applied voltage to a predetermined level to output the boosted voltage and may consist of an inductor L1. This inductor L1 generates the output voltage by charging the input voltage when the switching unit 220 is closed and discharges the charged output voltage when the switching unit 220 is opened.

The switching unit 220 is connected between the boost unit 210 and the rectifying unit 250 in parallel and switched according to a control signal applied from the control unit 240 to supply or interrupt the output voltage to the output terminal Vout.

In more detail, current, which varies in response to the control signal, that is, a gate control voltage V_{G}, flows in the switching unit 220. At this time, when the switching unit 220 is closed, current of the boost unit 210 is introduced into a drain terminal D of the switching unit 220 to flow to a source terminal S since a DC voltage is connected to both ends of the boost unit 210 to be charged while the switching unit 220 is closed.

If the switching unit 220 is opened, the voltage charged in the boost unit 210 is transmitted to the output unit 260 through the rectifying unit 250 to be applied to the load. This switching unit 220 is a switch device which can flow high current and may consist of a BJT, an IGBT, a MOSFET, and so on.

The detecting unit 230 is a means of detecting occurrence of overcurrent when a voltage applied to the switching unit 220 is higher than a preset reference voltage Vref and may include a sensing resistor 232 and Rs and a comparator 234.

Here, the sensing resistor 232 and Rs detects a voltage output from the source terminal of the switching unit 220, that is, the voltage applied to the switching unit 220, and the comparator 234 compares the voltage detected by the sensing resistor 232 and Rs with the reference voltage Vref and outputs an overcurrent signal when the voltage detected by the sensing resistor 232 and Rs is higher than the reference voltage Vref.

The control unit 240 performs a protection operation when overcurrent is detected more than a predetermined number of times within a predetermined time from when the overcurrent is detected.

More specifically, the control unit 240 performs a protection operation to open the switching unit 220 when the overcurrent is detected more than the predetermined number of times within the predetermined time from when the overcurrent is detected and on the contrary, closes the switching unit 220 to normally operate the power supply apparatus 200 when the overcurrent is detected less than the predetermined number of times within the predetermined time from when the overcurrent is detected.

This control unit 240 includes a counter 242, a delay unit 244, a protector 246, and a control signal generator 248, and detailed description of the same technical configuration as that of the control unit 240 previously described in FIG. 3 will be omitted.

The rectifying unit 250 and D1 as a means of preventing a back flow of current corresponding to the applied voltage consists of a diode and is connected to the inductor 210 in series. And, a cathode terminal, an output of the diode D1 is connected to the load to which the output voltage Vout is applied.

The output unit 260 is a means of discharging and outputting the DC voltage boosted by the boost unit 210 and may consist of a capacitor C1.

Meanwhile, when the power supply apparatus is a flyback converter, the converting unit 110 may consist of a transformer with a primary winding L1 and a secondary winding L2 to which power is induced from the primary winding L1.

At this time, the transformer supplies a voltage by inducing the voltage applied according to a PWM control signal from the primary winding L1 to the secondary winding L2, and the control unit 240 can vary the output voltage by opening or closing the switching unit 220 according to the fed-back output voltage F/B of a predetermined level.

As described above, according to a power supply apparatus in accordance with an embodiment of the present invention, it is possible to prevent malfunction due to noises by performing a protection operation when excessive current is detected more than a predetermined number of times within a predetermined time.

More specifically, it is possible to efficiently prevent malfunction due to noises by determining whether the overcurrent is detected more than the predetermined number of times within the predetermined time from when the overcurrent is detected, performing a protection operation when the overcurrent is detected more than the predetermined number of times within the predetermined time, and resetting the number of times the overcurrent is detected on the contrary when the overcurrent is detected less than the predetermined number of times.

As described above, although the preferable embodiments of the present invention have been shown and described, the present invention is not limited to the embodiments and it will be appreciated by those skilled in the art that various modifications and variations may be made without departing from the spirit of the present invention.

What is claimed is:

1. A power supply apparatus comprising:
a converting unit for converting an applied voltage into a predetermined level;
a switching unit opened or closed to control current flowing in the converting unit;
a detecting unit for detecting occurrence of overcurrent when a voltage applied to the switching unit is higher than a preset reference voltage; and
a control unit for performing a protection operation when the overcurrent is detected more than a predetermined number of times within a predetermined time from when the overcurrent is detected.

2. The power supply apparatus according to claim 1, wherein the control unit performs a protection operation to open the switching unit when the overcurrent is detected more than the predetermined number of times within the predetermined time from when the overcurrent is detected.

3. The power supply apparatus according to claim 1, wherein the control unit closes the switching unit when the overcurrent is detected less than the predetermined number of times within the predetermined time from when the overcurrent is detected.

4. The power supply apparatus according to claim 1, wherein the control unit comprises a counter for counting the number of times the overcurrent is detected.

5. The power supply apparatus according to claim 4, wherein the counter counts the number of times the overcurrent is detected within the predetermined time from when the overcurrent is detected.

6. The power supply apparatus according to claim 5, wherein the control unit further comprises a delay unit which detects the time elapsed from when the overcurrent is detected and resets information on the number of times of the overcurrent counted by the counter when the overcurrent is detected less than the predetermined number of times within the predetermined time.

7. The power supply apparatus according to claim 6, wherein the control unit further comprises a protector which performs a protection operation to open the switching unit when the overcurrent is detected more than the predetermined number of times within the predetermined time from when the overcurrent is detected.

8. The power supply apparatus according to claim 7, wherein the control unit further comprises a control signal generator which outputs a control signal for opening or closing the switching unit.

9. The power supply apparatus according to claim 8, wherein the control signal generator outputs the control signal for opening the switching unit when the protector performs a protection operation.

10. The power supply apparatus according to claim 1, wherein the detecting unit comprises a comparator which compares the voltage applied to the switching unit with the reference voltage and outputs an overcurrent signal when the voltage applied to the switching unit is higher than the reference voltage, and the control unit performs a protection operation when the overcurrent signal is output more than the predetermined number of times within the predetermined time from when the overcurrent signal is output.

11. The power supply apparatus according to claim 10, wherein the detecting unit further comprises a sensing resistor for detecting the voltage applied to the switching unit.

12. The power supply apparatus according to claim 11, wherein the voltage applied to the switching unit is a voltage output from a source terminal of the switching unit.

13. The power supply apparatus according to claim 1, wherein the converting unit is an inductor which boosts the applied voltage to a predetermined level.

14. The power supply apparatus according to claim 13, comprising:
a rectifying unit connected to the inductor in series to prevent a back flow of current; and
an output unit for discharging and outputting the voltage applied from the switching unit.

15. The power supply apparatus according to claim 14, wherein the control unit outputs the control signal for opening or closing the switching unit, and the switching unit is opened or closed according to the control signal output from the control unit to apply or interrupt the boosted voltage to the output unit.

16. The power supply apparatus according to claim 1, wherein the converting unit is a transformer with a primary winding and a secondary winding to which power is induced from the primary winding.

17. The power supply apparatus according to claim 1, wherein the power supply apparatus is an SMPS type.
